(19) United States
(12) Patent Application Publication
(10) Pub. No.: US 2007/0248432 A1
(43) Pub. Date: Oct. 25, 2007

(54) LOW COST/HIGH PERFORMANCE BLIND FASTENER

(76) Inventors: Gary G. Cassatt, Derby, KS (US); Dinh Q. Vu, Wichita, KS (US); Robert J. Mock, Wichita, KS (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/379,710

(22) Filed: Apr. 21, 2006

(51) Int. Cl. F16B 13/04

(52) U.S. Cl. 411/34

(57) ABSTRACT

A blind fastener is provided comprising a core bolt comprised of a bolt shaft and a bolt head. A metal sleeve is included comprising a rigid cylindrical base and a malleable cylindrical tail, the metal sleeve is positioned around the bolt shaft with the malleable cylindrical tail in communication with the bolt head. A travel stop feature is formed on the rigid cylindrical base opposite the malleable cylindrical tail. A drive feature includes a threaded bolt section extending from a foot end of the bolt shaft and a drive nut rotatably thereto. The drive nut allows the core bolt to be pulled within the metal sleeve such that the bolt head compresses the malleable cylindrical tail to form a retention button.

### TECHNICAL FIELD

The present invention relates generally to a low cost and high performance blind fastener, and, more particularly to blind fastener utilizing a malleable tail for retention button formation.

### BACKGROUND OF THE INVENTION

Aircraft manufacturing commonly relies on the ability to assemble complex assemblies within tight space limitations. As such, many manufacturing and assembly procedures require that parts must be installed and fastened together from only one side. To further complicate matters, the ever increasing prevalence of composite structures within the aircraft are often unsuitable for traditional fastening methodologies such as rivets wherein the composite structures may sustain damage during the fastening procedure.

As such, the use of blind fasteners, or fasteners that install from only one side, has been commonplace in aircraft manufacturing for many years. Existing blind fasteners, however, are often limited in strength or are heavy and expensive in comparison to solid shank fasteners. Close out structure designs in highly loaded areas must compensate for performance limits with heavier structures and increased numbers of fasteners. This generates undesirable cost increase, increases in manufacturing time, and negatively impacts the weight savings that commonly drive aircraft design. What is needed is a design that incorporates the cost effectiveness and performance characteristics of solid shank fasteners (such as traditional bolt assemblies) with the unique installation benefits of blind fasteners.

It would, however, be highly desirable to have a blind fastener that incorporated the cost effective and positive performance of solid shank fasteners in a blind fastener design. Similarly, it would be highly desirable to have a blind fastener that was suited to handle the joining of composite structures without sacrificing fastening strength.

### SUMMARY OF THE INVENTION

A blind fastener is provided comprising a core bolt comprised of a bolt shaft and a bolt head. A metal sleeve is included comprising a rigid cylindrical base and a malleable cylindrical tail, the metal sleeve is positioned around the bolt shaft with the malleable cylindrical tail in communication with the bolt head. A travel stop feature is formed on the rigid cylindrical base opposite the malleable cylindrical tail. A drive feature includes a threaded bolt section extending from a foot end of the bolt shaft and a drive nut rotatably thereto. The drive nut allows the core bolt to be pulled within the metal sleeve such that the bolt head compresses the malleable cylindrical tail to form a retention button.

Other features of the present invention will become apparent when viewed in light of the detailed description of the preferred embodiment when taken in conjunction with the attached drawings and appended claims.

### BRIEF DESCRIPTION OF THE DRAWINGS

FIG. 1 is an exploded view illustration blind fastener in accordance with the present invention;

FIG. 2 is an illustration of the blind fastener illustrated in FIG. 1, the blind fastener shown inserted through a first joinable element and a second joinable element;

FIG. 3 is an illustration of the blind fastener illustrated in FIG. 1, the blind fastener illustrated forming a retention button; and

FIG. 4 is an illustration blind fastener illustrated in FIG. 1, the illustration showing the use of a break-neck feature on the drive feature.

### DESCRIPTION OF THE PREFERRED EMBODIMENT(S)

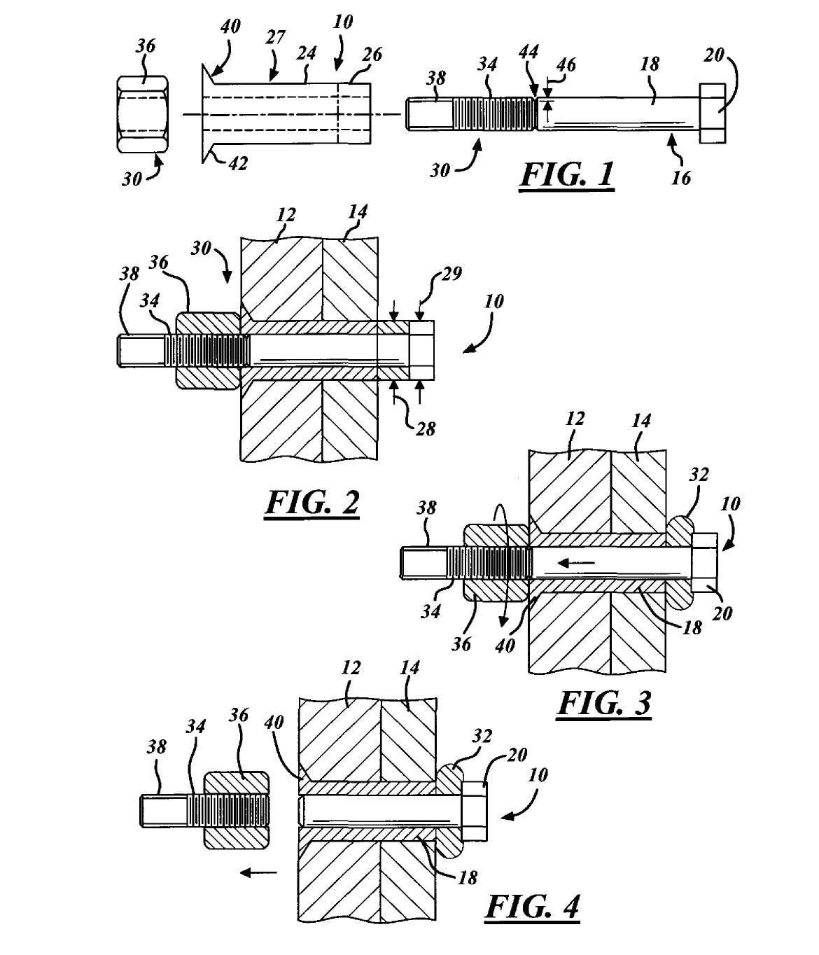

Referring now to FIG. 1, which is an illustration of a blind fastener 10 in accordance with the present invention. The blind fastener 10 was developed to join a first joinable element 12 to a second joinable element 14 while only requiring access from a single side. The present invention was developed specifically for aircraft and aerospace applications, although a variety of alternate uses will become apparent in view of the present disclosure. Although the first and second joinable elements 12, 14 may be any of a wide variety of elements and may be composed of a wide variety of materials, in one embodiment it is contemplated that the first joinable element be comprised of a metal panel and the second joinable element 14 be composed of a composite panel. Joining composites to metals often gives rise to assembly difficulties due to the inappropriateness of metal fasteners such as rivets to composites.

The present invention addresses these and other blind fastening (from a single side) issues through the use of a blind fastener 10 comprised of a core bolt 16 made up of a bolt shaft 18 and a bolt head 20. The core bolt 16 is preferably comprised of a metal alloy, although a wide variety of materials may be utilized. The blind fastener 10 further comprises a metal sleeve 22, preferably cylindrical, configured to surround the bolt shaft 18 with the bolt shaft 18 inserted through the sleeve 22. The metal sleeve 22 includes two cylindrical in-line sections. The first is a rigid cylindrical base 24 configured of a material sufficiently strong to withstand fastening loads. The second is a malleable cylindrical tail 26. The rigid cylindrical base 24 and the malleable cylindrical tail 26 preferably share the same sleeve outer diameter 28. In addition, it is contemplated that the sleeve outer diameter 28 be substantially the same as the bolt head outer diameter 29. The malleable cylindrical tail 26 is preferably in communication with the bolt head 20 when the metal sleeve 22 is positioned around the bolt shaft 18. It is also preferred that the malleable cylindrical tail 26 is permanently affixed to the bolt head 20 such as through bonding, brazing, welding, spin welding, or frictional welding. Although a number of permanent attachment methodologies have been described, a wide variety are contemplated.

The blind fastener 10 further includes a drive feature 30 positioned on the bolt shaft 18 opposite the bolt head 20 to provide a means for the core bolt 16 to be pulled within the metal sleeve 22 such that the bolt head 20 exerts a compressive force on the malleable cylindrical tail 26. The blind fastener 10 is inserted through the joinable elements 12, 14 (see FIG. 2) and the drive feature 30 is used to exert the compressive force. Upon exerting the compressive force, the bolt head 20 compresses the malleable cylindrical tail 26 until it forms a retention button 32 (see FIG. 3). The malleable cylindrical tail 26 is preferably formed from an alloy that becomes work hardened as the retention button 32 is formed. In this fashion the retention button is formed on a remote side of the joinable elements 12,14 without requiring installation access. The malleable cylindrical tail 26 may be formed from a variety of materials. However, in two specific embodiments contemplate the use of titanium-columbium or aluminum alloys.

Although a generic drive feature has been described, one embodiment contemplates the use of a drive feature 30 comprised of a threaded bolt section 34 extending from the bolt shaft 18 and a drive nut 36 engaged thereto, By torquing on the drive nut 36, the desired compressive force may be exerted onto the core bolt 16 in order to begin compression of the malleable cylindrical tail 26. A wrench flat 38 feature formed on the trailing end of the threaded bolt section 34 allows the core bolt 16 to be rotationally held while the drive nut 36 is turned. A travel stop feature 40 is formed on the end of the rigid cylindrical base 24 in order to limit the insertion length of the blind fastener 10 and provides a countervailing load to the retention button 32 formation. This allows the joinable feature 12,14 to be compressed between the travel stop feature 40 and the retention button 32. Although a variety of travel stop features 40 are contemplated, one embodiment contemplates the use of an outwardly flanged feature 42. This type of travel stop 40 is highly useful in engaging metal surfaces. The retention button 32, however, is suitable for a wide variety of surfaces including composites.

In addition to the aforementioned features, the present invention contemplates a few more additional novel characteristics. One such characteristic is the inclusion of a break neck groove 44, such as a v-groove. The break neck groove 44 is positioned between the drive feature 30 (threaded bolt section 34) and the bolt shaft 18. This allows the drive feature to be broken off after installation and formation of the retention button 32 (see FIG. 4). In addition, it is contemplated that the v-groove depth 46 and/or v-groove location 48 may be designed such that the break neck groove 44 breaks when the compressive force is sufficient to form the retention button 32. In this fashion, the retention button 32 can be formed simply and reliably while automating the removal of the drive feature 30.

While particular embodiments of the invention have been shown and described, numerous variations and alternative embodiments will occur to those skilled in the art. Accordingly, it is intended that the invention be limited only in terms of the appended claims.

What is claimed is:

1. A blind fastener comprising:
a core bolt comprising a bolt shaft and a bolt head;
a metal sleeve comprising a rigid cylindrical base and a malleable cylindrical tail, said metal sleeve positioned around said bolt shaft with said malleable cylindrical tail in communication with said bolt head; and
a drive feature positioned on said bolt shaft opposite said bolt head, said drive feature allowing said core bolt to be pulled within said metal sleeve such that said bolt head compresses said malleable cylindrical tail to form a retention button.

2. A blind fastener as described in claim 1, further comprising:
a travel stop feature formed on said rigid cylindrical base opposite said malleable cylindrical tail.

3. A blind fastener described in claim 2, wherein said travel stop feature comprises an outwardly flanged feature.

4. A blind fastener as described in claim 1, wherein said drive feature comprises:
a threaded bolt section extending from a foot end of said bolt shaft; and
a drive nut rotatably mounted to said threaded bolt section.

5. A blind fastener as described in claim 4, further comprising:
a break-neck groove formed between said threaded bolt section and said bold shaft, said break-neck groove allowing said drive feature to be snapped off after installation.

6. A blind fastener as described in claim 1, wherein said malleable cylindrical tail is permanently affixed to said bolt head.

7. A blind fastener as described in claim 6, wherein said malleable cylindrical tail is permanently affixed to said bolt head by a means taken from the group of bonding, brazing, welding, spin welding, and frictional welding.

8. A blind fastener as described in claim 1, wherein said metal sleeve comprises a sleeve outer diameter approximately equal to a bolt head outer diameter.

9. A blind fastener as described in claim 1, wherein said malleable cylindrical tail comprises a titanium-columbium alloy.

10. A blind fastener as described in claim 5, wherein said break-neck groove comprises:
a v-groove having a v-groove location and a v-groove depth configured to break upon said drive feature exceeding the force required to form said retention button.

11. A blind fastener as described in claim 4, further comprising:
a wrench flat formed on said threaded bolt section.

12. A blind fastener comprising:
a core bolt comprising a bolt shaft and a bolt head;
a metal sleeve comprising a rigid cylindrical base and a malleable cylindrical tail, said metal sleeve positioned around said bolt shaft with said malleable cylindrical tail in communication with said bolt head;
a travel stop feature formed on said rigid cylindrical base opposite said malleable cylindrical tail; and
a drive feature comprising a threaded bolt section extending from a foot end of said bolt shaft and a drive nut rotatably mounted to said threaded bolt section, said drive nut allowing said core bolt to be pulled within said metal sleeve such that said bolt head compresses said malleable cylindrical tail to form a retention button.

13. A blind fastener described in claim 12, wherein said travel stop feature comprises an outwardly flanged feature.

14. A blind fastener as described in claim 12, further comprising:
a break-neck groove formed between said threaded bolt section and said bold shaft, said break-neck groove allowing said drive feature to be snapped off after installation.

15. A blind fastener as described in claim 14, wherein said break-neck groove comprises:
a v-groove having a v-groove depth configured to break upon said drive feature exceeding the force required to form said retention button.

16. A blind fastener as described in claim 14, wherein said break-neck groove comprises:
a v-groove having a v-groove location configured to break upon said drive feature exceeding the force required to form said retention button.

17. A blind fastener as described in claim 12, wherein said malleable cylindrical tail is permanently affixed to said bolt head.

18. A blind fastener as described in claim 12, wherein said malleable cylindrical tail comprises a titanium-columbium alloy.

19. A blind fastener as described in claim 12, wherein said malleable cylindrical tail comprises an aluminum alloy.

20. A method of joining a first material to a second material using a blind fastener, the method comprising:
inserting a blind fastener through the first material and second material, said blind fastener comprising:
a core bolt comprising a bolt shaft and a bolt head;
a metal sleeve comprising a rigid cylindrical base and a malleable cylindrical tail, said metal sleeve positioned around said bolt shaft with said malleable cylindrical tail in communication with said bolt head;
inserting said blind fastener until a travel stop feature formed on said rigid cylindrical base opposite said malleable cylindrical tail engages said first material;
torquing a drive feature formed onto said bolt shaft, said drive feature comprising a threaded bolt section extending from a foot end of said bolt shaft and a drive nut rotatably mounted to said threaded bolt section, said drive nut pulling said core bolt within said metal sleeve such that said bolt head compresses said malleable cylindrical tail to form a retention button;
generating a compression torque securing the first material to the second material by way of pressure between said travel stop feature and said retention button.

21. A method as described in claim 20, further comprising:
breaking said drive feature off of said bolt shaft after forming said retention button.

22. A method as described in claim 20, further comprising:
torquing said drive feature until a v-groove breaks, said v-groove breaking upon said drive feature exceeding the force required to form said retention button.

23. A method as described in claim 21, wherein:
said malleable cylindrical tail is permanently affixed to said bolt head such that said core bolt is retained within said metal sleeve after said drive feature is broken off.
